(19) United States
(12) Patent Application Publication
(10) Pub. No.: US 2009/0183114 A1
(43) Pub. Date: Jul. 16, 2009

(54) Information processing apparatus and computer program product

(75) Inventor: Fabrice Matulic, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/314,833

(22) Filed: Dec. 17, 2008

(30) Foreign Application Priority Data
Jan. 11, 2008 (JP) 2008-004801

(51) Int. Cl. G06F 3/00

(52) U.S. Cl. 715/810

(57) ABSTRACT

A storing unit stores therein a symbol of the data file. The symbol includes image information of the data file and attribute information of the data file indicating the attribute of the data file. A display unit displays thereon the symbol. A receiving unit receives a selection instruction of selecting the symbol displayed on the display unit. Upon the receiving unit receiving the selection instruction, a display control unit sequentially displays a plurality of pieces of image information included in the symbol on the display unit.

### CROSS-REFERENCE TO RELATED APPLICATIONS

The present application claims priority to and incorporates by reference the entire contents of Japanese priority document 2008-004801 filed in Japan on Jan. 11, 2008.

### BACKGROUND OF THE INVENTION

1. Field of the Invention

The present invention relates to an information processing apparatus and a computer program product for the information processing apparatus.

2. Description of the Related Art

In a typical information processing apparatus such as a personal computer, when a user wants to open a document data or an image data created by various applications, the user clicks an icon of the document data or the image data expressed with a small picture or a symbol displayed on an operating system by using a keyboard, a mouse, or the like, and then an application starts up to open the document data or the image data.

The icon is often displayed as a thumbnail image that represents an application used for creating the data, a file name of the data, the content of the first page of the data, features of the data, and the like.

For example, a technology is disclosed in Japanese Patent Application Laid-open No. 2007-150858, in which a document editing apparatus can edit the content (e.g., a character string and an image) of a document by a drawing operation by a pointing device displayed on an operation display and display the content of the edited document on an icon as a graphic.

However, in the above technology, the content of the document selected by a user is displayed as an icon of a still image. Therefore, when the user wants to confirm the content of the document other than that displayed on the icon, the user needs to, for example, click the icon to open the document and further needs to scroll pages to a desired position or search for a keyword. In other words, the user needs to perform complex operations, which results in placing a burden on the user and taking a long time to confirm the content by the user.

### SUMMARY OF THE INVENTION

It is an object of the present invention to at least partially solve the problems in the conventional technology.

According to one aspect of the present invention, there is provided an information processing apparatus that displays an attribute of a data file. The information processing apparatus includes a storing unit that stores therein a symbol of the data file, the symbol including image information of the data file and attribute information of the data file indicating the attribute of the data file; a display unit that displays thereon the symbol; a receiving unit that receives a selection instruction of selecting the symbol displayed on the display unit; and a display control unit that, upon the receiving unit receiving the selection instruction, sequentially displays a plurality of pieces of image information included in the symbol on the display unit.

Furthermore, according to another aspect of the present invention, there is provided a computer program product including a computer-usable medium having computer-readable program codes embodied in the medium for an information processing apparatus that displays an attribute of a data file. The program codes when executed cause a computer to execute storing a symbol of the data file, the symbol including image information of the data file and attribute information of the data file indicating the attribute of the data file; displaying the symbol on a display unit; receiving a selection instruction of selecting the symbol displayed at the displaying; and controlling including, when the selection instruction is received at the receiving, sequentially displaying a plurality of pieces of image information included in the symbol on the display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an information processing system according to a first embodiment of the present invention;

FIG. 2 is a schematic diagram of an example of an input screen displayed on a display unit of a client terminal shown in FIG. 1;

FIG. 3 is a schematic diagram of an example of an icon displayed on the display unit;

FIG. 4 is a schematic diagram of an example of an operation of the icon;

FIGS. 5A to 5D are schematic diagrams for explaining a method of controlling display of the icon;

FIGS. 6A and 6B are tables stored in a storing unit of a server shown in FIG. 1, in each of which an attribute of a data file, an icon creation target, and an attribute image target are associated with each other.

FIGS. 7A and 7B are schematic diagrams each for explaining a procedure for creating an image in an icon format;

FIG. 8 is a flowchart of a procedure of processes for creating an image in an icon format;

FIG. 9 is a block diagram of an information processing system according to a second embodiment of the present invention;

FIG. 10 is a flowchart of a procedure of processes for creating an image in an icon format;

FIG. 11 is a schematic diagram of an example of a screen of a display unit of a client terminal shown in FIG. 9 on which images in an icon format are displayed;

FIG. 12 is a schematic diagram of an example of a screen on which one of the images shown in FIG. 11 is enlarged; and

FIG. 13 is a block diagram of an information processing system according to a third embodiment of the present invention.

### DETAILED DESCRIPTION OF THE PREFERRED EMBODIMENTS

Exemplary embodiments of the present invention are explained in detail below with reference to the accompanying drawings.

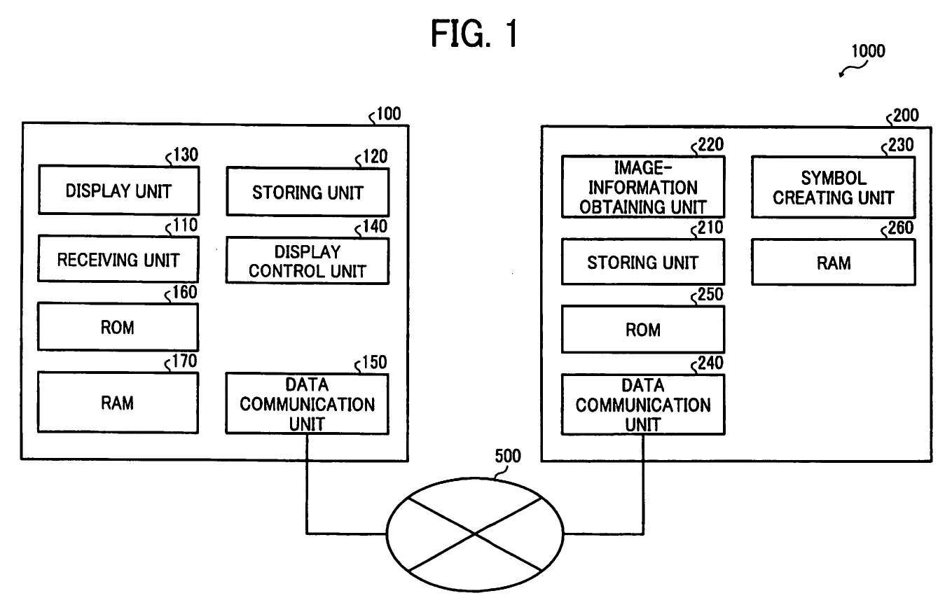

FIG. 1 is a block diagram of an information processing system 1000 according to a first embodiment of the present invention. The information processing system 1000 includes a client terminal 100, a server 200, and a network 500.

The client terminal 100 includes a receiving unit 110, a storing unit 120, a display unit 130, a display control unit 140, a data communication unit 150, a read only memory (ROM) 160, and a random access memory (RAM) 170. The server 200 includes a storing unit 210, an image-information obtaining unit 220, a symbol creating unit 230, a data communication unit 240, a ROM 250, and a RAM 260.

The storing unit 120 stores therein data files such as document files and image data. The receiving unit 110 includes a keyboard, a mouse, and a touch panel. The receiving unit 110 receives an input of information specified by a user such as a file name of a data file of which icon is created among the data files in the storing unit 120 and an icon creation target (e.g., page, title, paragraph, column, embedded image) of which an image is created to be displayed as an icon in the data file, i.e., which portion in the data file is displayed as an icon.

An icon includes attribute information of a data file and an image of the specified icon creation target in the data file.

The attribute information includes a type of an application by which a data file is created, information on whether the data file is a still image or a moving image and whether the data file is for a catalogue or a paperback book, date and time of creation of the data file, a file name of the data file, and an image (hereinafter, “attribute image”) representing characteristics of the data file such as an image of the first page or a cover of the data file. That is, an icon includes the attribute information including the attribute image and an image created by converting the content of a page of a data file.

In the present embodiment, the attribute image is created in accordance with the setting stored in advance in the storing unit 210. However, for example, when a user has specified a page of a data file as the attribute image in the receiving unit 110, an image created by converting the content of the page can be used as the attribute image.

A data file includes various files of HyperText Markup Language (HTML) data containing data such as characters, diagrams, sound, and moving images, Extensible Markup Language (XML) data, data created by a word processor, Portable Document Format (PDF) data, data created in Open Document Format (ODF), and e-mail data, and an object created by various media such as a flash object.

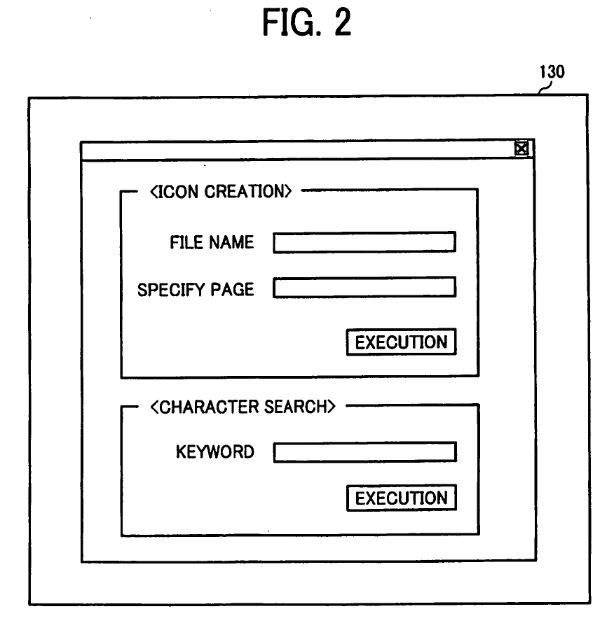

FIG. 2 is a schematic diagram of an example of an input screen for inputting a file name of a data file and the icon creation target to be displayed as an icon. When a user inputs necessary information on the input screen and presses an execution button, the image-information obtaining unit 220 and the symbol creating unit 230 creates an icon based on the information. The receiving unit 110 sometimes cannot receive an input of a page number, which will be described later.

The receiving unit 110 receives an input such as a keyword for searching for a character string included in an image of each page included in an icon created by the server 200, a file name of a data file, and an instruction to open a page of the data file of the same page number of the image, for example, by a user double-clicking the image with the mouse.

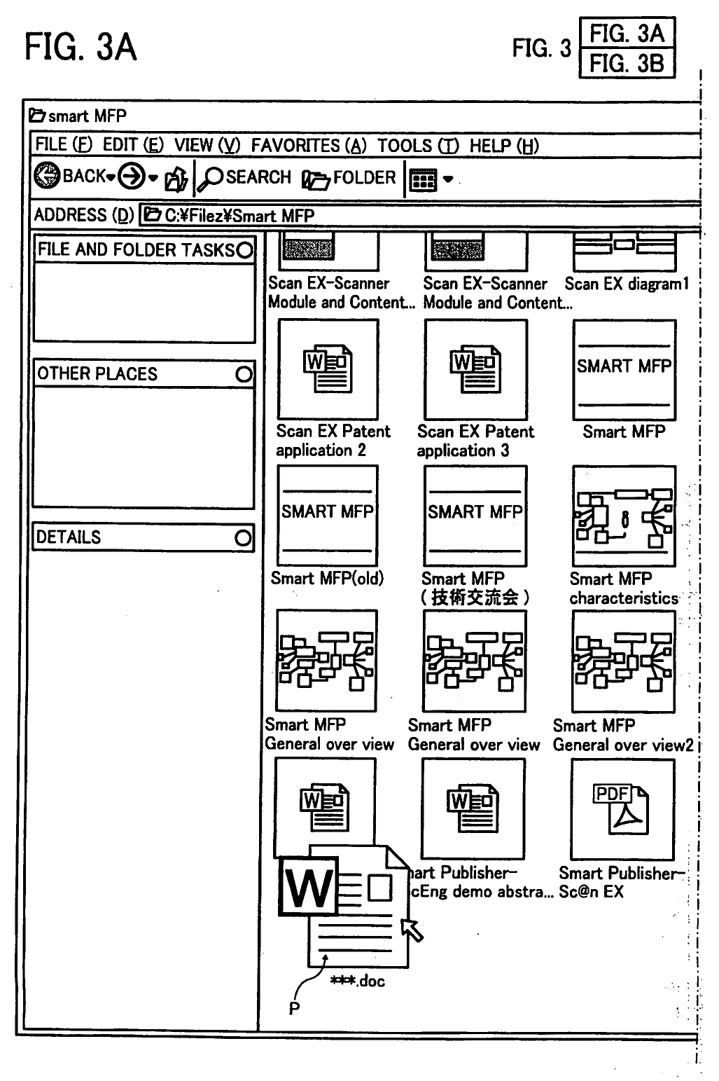

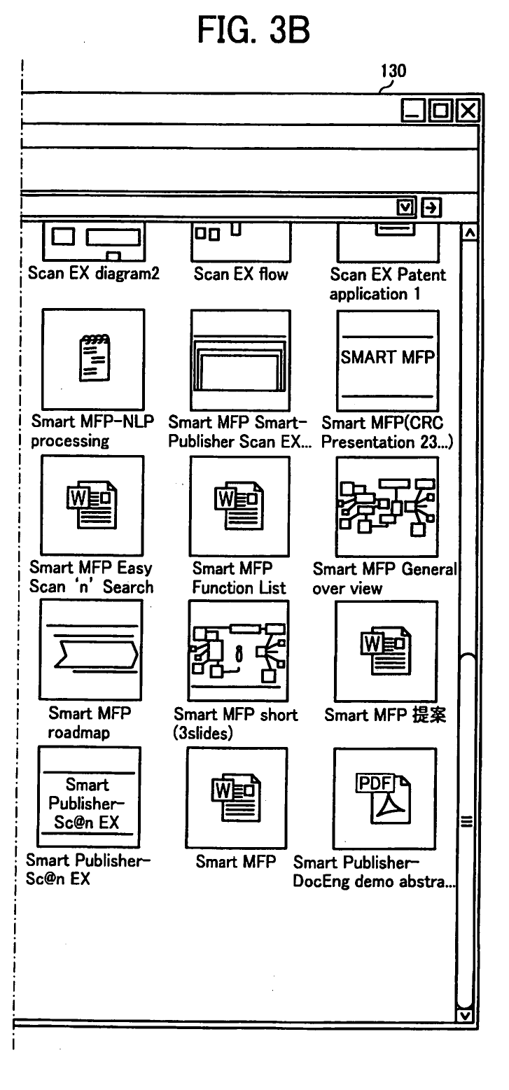

The storing unit 120 is, for example, a hard disk drive (HDD) or a memory, and stores therein, in addition to data files, icons of data files received from the server 200 as shown in FIG. 3, applications (e.g., Microsoft Word (trademark)) by which the data files are created, and the like.

The display unit 130 includes a display device such as a liquid crystal display, and displays the input screen shown in FIG. 2, icons created through various processes, the content of data files, and the like.

The display control unit 140 controls an operation of displaying icons received from the server 200 based on the instruction that the receiving unit 110 has received from a user.

Specifically, as shown in FIG. 3, when a user moves a mouse pointer over a created icon P of a data file, the display control unit 140 controls to display an enlarged attribute image of the icon P. When the user clicks the enlarged attribute image, the display control unit 140 controls to display an image of the first page of the data file. In the case, however, for example, the display control unit 140 can control to display an image of a page of the data file specified in advance by a user.

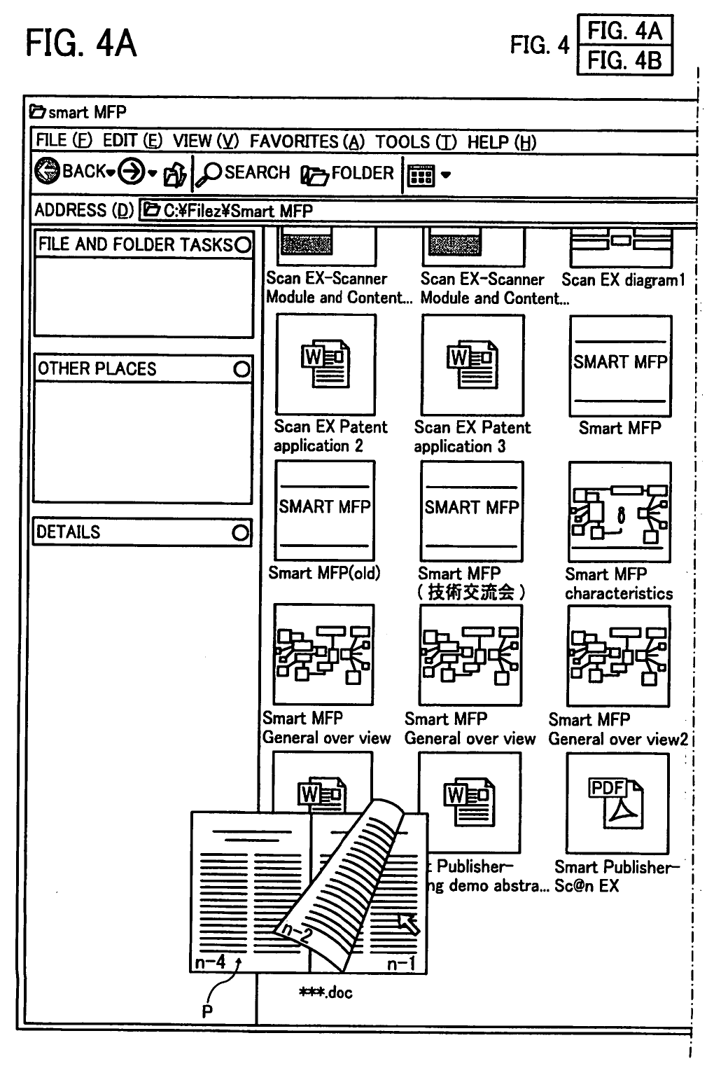

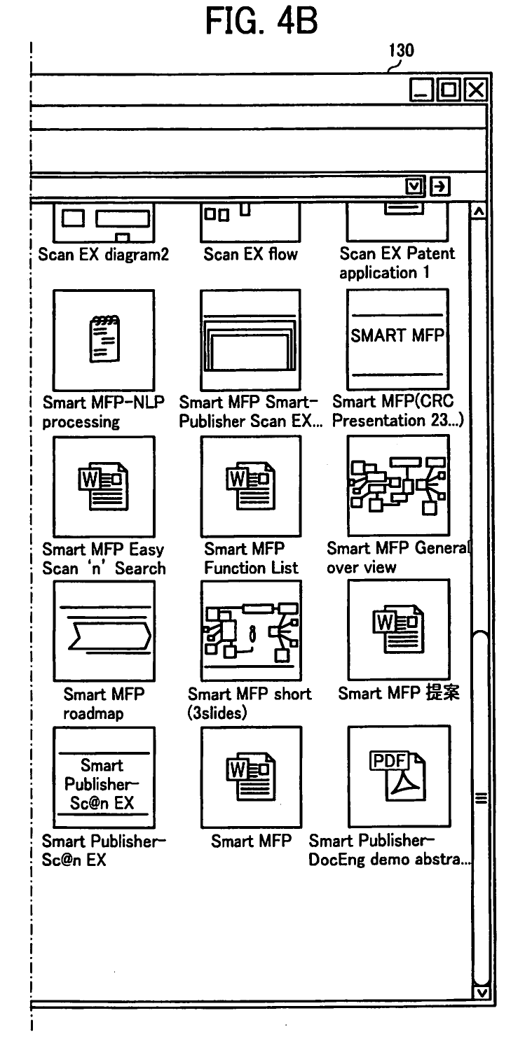

As shown in FIG. 4, when the receiving unit 110 receives the operation of moving the mouse pointer right and left on the icon P, the display control unit 140 controls to display so that an image of each page of the icon P is turned over corresponding to the operation. Furthermore, when a user clicks an image of a page included in the icon P, the display control unit 140 controls to display an enlarged (reduced) image of the page.

For example, when the icon P is created for a data file “***.doc” as shown in FIG. 4 and the receiving unit 110 receives the operation of moving the mouse pointer right and left on the icon P, the display control unit 140 controls to display so that an image of each page included in the icon P is turned over.

Furthermore, when an icon is displayed on the display unit 130 and the receiving unit 110 receives an instruction (click) to open a data file of the icon, for example, by a user double-clicking the icon with the mouse, the display control unit 140 refers to a page number of the icon displayed on the display unit 130. Then, the display control unit 140 starts up an application to open the data file and displays on the display unit 130 the page of the data file same as the page that the display control unit 140 referred to.

Specifically, for example, when an image of the (n−1)th page of the icon P is displayed as shown in FIG. 4 and a user double-clicks the image with a mouse, the display control unit 140 reads a page number of the image.

Then, the display control unit 140 starts up an application stored in the storing unit 120 to open the data file “***.doc”, and causes the display unit 130 to display an image of the (n−1)th page of the data file.

As the attribute image of an icon as shown in FIG. 3, i.e., in the state where an image of each page included in the icon has not been opened, the display control unit 140 causes the display unit 130 to display the first page of the data file.

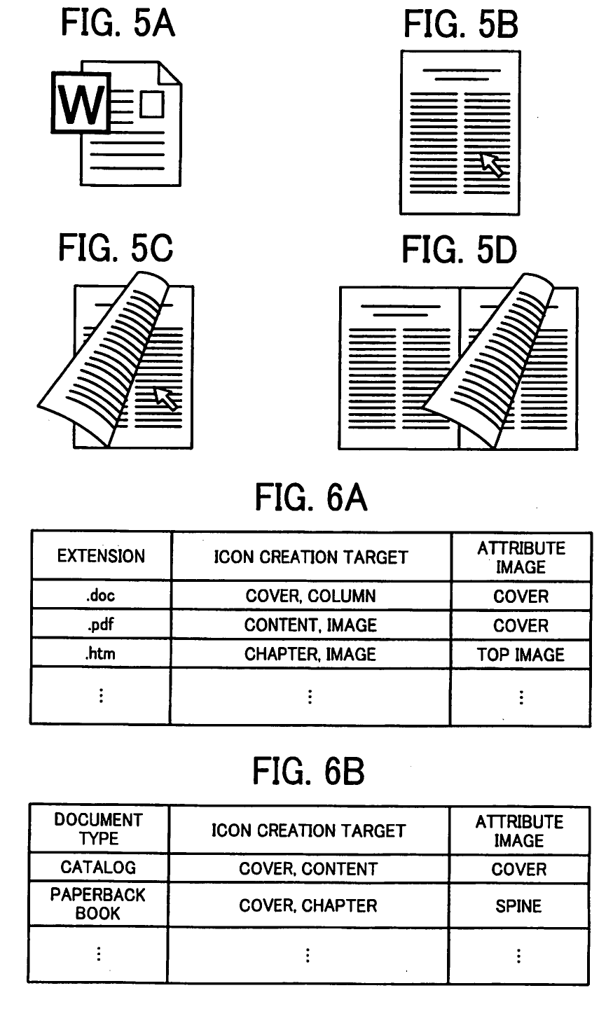

The method of controlling display of an icon by the display control unit 140 is specifically explained with reference to FIGS. 5A to 5D.

FIG. 5A is a schematic diagram illustrating a state of an icon (attribute image) that is created by the server 200 and is just received by the data communication unit 150, i.e., a state where the receiving unit 110 has not received any instruction or operation to the icon from a user. In FIG. 5A, the icon of a document file in Microsoft Word is illustrated as an example.

FIG. 5B is a schematic diagram illustrating a state of the icon that is displayed when the user clicks the attribute image shown in FIG. 5A with the mouse pointer. As shown in FIG. 5B, when the receiving unit 110 receives an instruction from the user, for example, when the user clicks the attribute image shown in FIG. 5A with the mouse, the display control unit 140 causes the display unit 130 to display an image of the first page of the data file on the icon.

Then, when the receiving unit 110 receives an instruction to move the mouse pointer right and left on the icon, the display control unit 140 controls the operation of displaying the icon to turn over a page of the icon in accordance with the movement of the mouse pointer as shown in FIG. 5C.

FIG. 5D is a schematic diagram illustrating a state of the icon when the receiving unit 110 receives an instruction to move the mouse pointer right and left on the icon from the state shown in FIG. 5C. In this manner, by continuously moving the mouse pointer right and left on the icon, the user can confirm the content of the data file as if the user opens a book and turn over the pages.

In the above explanation, the display control unit 140 controls to turn over a page of the icon in accordance with the movement of the mouse pointer. However, the display control unit 140 can control to turn over a page by a user clicking the mouse over an image of each page like a slide show. In other words, any method can be employed as long as an image of each page can be displayed.

Moreover, when the receiving unit 110 receives an input of a keyword for searching, the display control unit 140 searches mapping data representing position information of character strings embedded in the icon, and highlights the character strings same as the keyword included in the image of the icon.

The data communication unit 150 is a data communication interface between the client terminal 100 and the server 200, and transmits to the server 200 via the network 500 a data file of which an icon is created in addition to a file name and the icon creation target of which an input has been received by the receiving unit 110. Moreover, the data communication unit 150 receives an icon created by the image-information obtaining unit 220 and the symbol creating unit 230 via the network 500.

The ROM 160 is a storage memory for storing therein computer programs for controlling each unit such as the receiving unit 110 and the display control unit 140.

The RAM 170 is a loading memory for temporarily storing therein a file name of which input has been received by the receiving unit 110, a data file of which icon is created, and an icon that is created by the server 200 and received by the data communication unit 150.

The storing unit 210 is, for example, an HDD or a memory, and stores therein data in which an attribute of a data file, the icon creation target (e.g., page, title, paragraph, presence or absence of an image) in the data file, and an attribute image target to be an attribute image of an icon created from a data file are associated with each other as shown in FIGS. 6A and 6B.

For example, in the top row in FIG. 6A, an extension “.doc” as the attribute of a data file, “cover” and “page including a column” as the icon creation target in the data file of the extension “.doc”, and “cover” as the attribute image target of the data file are associated with each other. In the second row in FIG. 6A, an extension “.pdf” as the attribute of the data file, “content” and “page including an image” as the icon creation target in the data file of the extension “.pdf”, and “cover” as the attribute image target of the data file are associated with each other.

Even when a column or the like is not actually illustrated as “column” on a page of a data file, it is possible to determine whether the page includes a column with a symbol or a code indicating a column in the page. Alternatively, a user can set in advance pages that include a column or the like. In other words, the icon creation target can be represented by a symbol, a code, or the like indicating the icon creation target.

In the top row in FIG. 6B, “catalog” as a document type, “cover” and “content” as the icon creation target in the data file of this document type, and “cover” as the attribute image target of the data file are associated with each other. In the second row in FIG. 6B, “paperback book” as the document type, “cover” and “chapter” as the icon creation target in the data file of this document type, and “spine” as the attribute image target of the data file are associated with each other. The document type is set in advance by a user same as the icon creation target.

When the data communication unit 240 receives a data file and the icon creation target such as a page number from the client terminal 100, the image-information obtaining unit 220 opens the data file. Then, the image-information obtaining unit 220 reads from the opened data file a page corresponding to the attribute image target stored in the storing unit 210 to convert the page into an image, and stores the image in the RAM 260 as the attribute image of an icon.

Moreover, the image-information obtaining unit 220 refers to the page number specified as the icon creation target received from the client terminal 100 to read the page of the same page number from the data file to convert the page into an image and stores the image in the RAM 260.

Even when a page number is not specified by a user, the image-information obtaining unit 220 refers to an extension or a document type of the data file received from the client terminal 100 to convert the icon creation target (e.g., a cover and a page including a column) corresponding to the extension or the document type into an image and stores the image in the RAM 260.

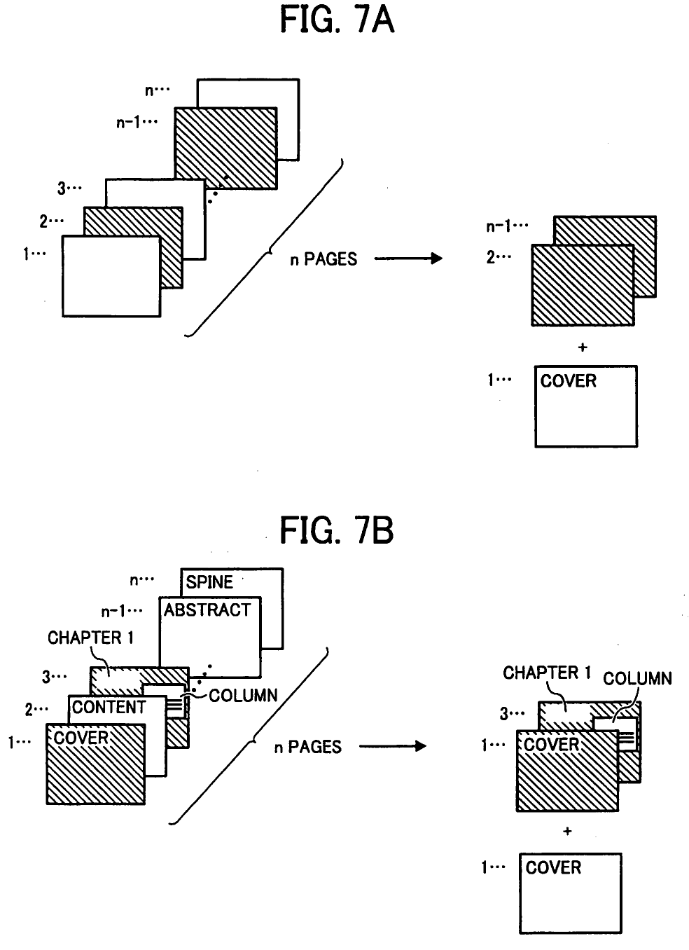

For example, as shown in FIG. 7A, the image-information obtaining unit 220 converts pages or a page number thereof (e.g., second page and (n−1)th page) in the data file including a plurality of pages (e.g., n pages) that is received from the client terminal 100 into images and stores the images in the RAM 260.

Moreover, the image-information obtaining unit 220 refers to an extension of the data file to read a page that matches a page (e.g., page to be a cover) as the attribute image target stored in the storing unit 210 from the data file. Then, the image-information obtaining unit 220 converts the page into an image and stores the image as the attribute image in the RAM 260.

When a page number is not specified by a user from the client terminal 100, as shown in FIG. 7B, the image-information obtaining unit 220 refers to the attribute of the data file (e.g., extension or document type), and specifies pages (e.g., pages including a cover and a column) as the icon creation target and a page (e.g., page to be a cover) as the attribute image target stored in the storing unit 210. Then, the image-information obtaining unit 220 reads the specified pages from the data file and converts them into images to store them in the RAM 260.

When converting pages into images, the image-information obtaining unit 220 reads the pages of the data file received on-the-fly, converts the read pages into the images one by one, and outputs the images to the symbol creating unit 230. In this manner, it is possible to reduce the use of disk capacity for image conversion of the storing unit 210.

The symbol creating unit 230 confirms whether the attribute image created by the image-information obtaining unit 220 has been created in the RAM 260. When the attribute image has been created in the RAM 260, the symbol creating unit 230 creates the mapping data indicating positions of character strings included in an image of each page. The mapping data is, for example, data representing coordinates of positions of character strings such as coordinate data “(abc, 1, 1, 1)” that indicates that a character string “abc” is positioned at the first row of the first column of the first page.

Moreover, the symbol creating unit 230 combines the created attribute image, the images of respective pages, and the mapping data, and reduces the combined image to an image for icon. The mapping data is created because, when an icon is created, a user can search for a character string included in the image of each page of the icon, for example, from the input screen shown in FIG. 2. The display control unit 140, for example, highlights searched character strings, so that the user can confirm a result of searching at a glance.

The image for icon created by the symbol creating unit 230 is renewed every time a page read by the image-information obtaining unit 220 is converted into an image and is stored in the RAM 260.

The data communication unit 240 is a data communication interface between the server 200 and the client terminal 100, and receives a file name, the icon creation target, and a data file of which an icon is created transmitted from the data communication unit 150. Moreover, the data communication unit 240 transmits an icon created by the image-information obtaining unit 220 and the symbol creating unit 230 to the client terminal 100 via the network 500.

The ROM 250 is a storage memory for storing therein computer programs for controlling each unit such as the image-information obtaining unit 220 and the symbol creating unit 230.

The RAM 260 is a loading memory for temporarily storing therein an image of each page and an attribute image of a data file converted by the image-information obtaining unit 220.

The network 500 enables communication between the data communication unit 150 and the data communication unit 240, and is for example the Internet, a local area network (LAN), or a wireless LAN.

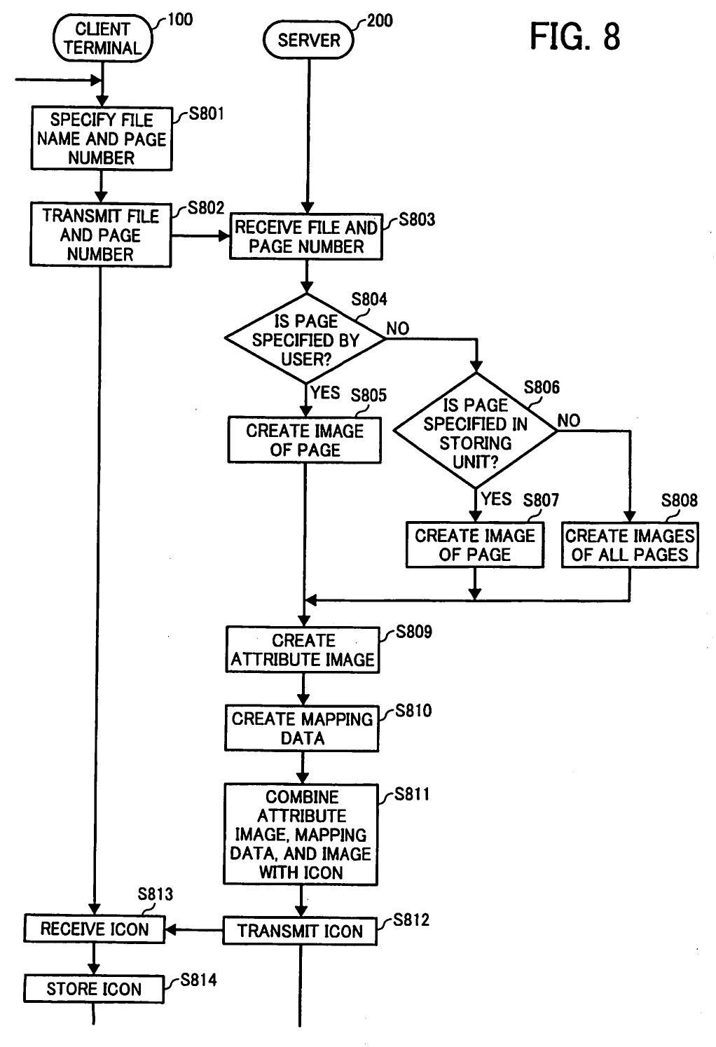

Processes performed by the information processing system 1000 are explained with reference to FIG. 8.

FIG. 8 is a flowchart of a procedure of processes for creating an icon when a data file (file name: ***.doc) and pages (e.g., second page and (n−1)th page in FIG. 7A) as the icon creation target are specified from the receiving unit 110. An extension as the attribute of the data file and the icon creation target in the data file of the extension are associated with each other as shown in FIG. 6A to be stored in the storing unit 210.

When the receiving unit 110 receives an input of a file name and a page number as the icon creation target by a user operating a keyboard or the like (Step S801), the data communication unit 150 transmits a data file stored in the storing unit 120 of which a file name is the same as that received by the receiving unit 110 and the page number received by the receiving unit 110 at Step S801 to the server 200 (Step S802).

When the data communication unit 240 receives the data file and the like (Step S803), the image-information obtaining unit 220 confirms whether pages as the icon creation target are specified together with the data file (Step S804).

If the image-information obtaining unit 220 confirms that pages as the icon creation target are specified (YES at Step S804), the image-information obtaining unit 220 reads the pages to convert them into images and stores the images in the RAM 260 (Step S805).

If the image-information obtaining unit 220 confirms that pages as the icon creation target are not specified (NO at Step S804), the image-information obtaining unit 220 refers to an extension of the data file and confirms whether pages as the icon creation target are specified in the storing unit 210 for the data file of the extension (Step S806).

Then, when the image-information obtaining unit 220 confirms that pages as the icon creation target corresponding to the extension are specified in the storing unit 210 (YES at Step S806), the image-information obtaining unit 220 identifies the pages corresponding to the extension to convert them into images and stores the images in the RAM 260 (Step S807).

When the image-information obtaining unit 220 confirms that pages as the icon creation target corresponding to the extension are not specified in the storing unit 210 (NO at Step S806), the image-information obtaining unit 220 converts all pages in the data file received at Step S803 into images and stores them in the RAM 260 (Step S808).

Each process from Step S805 to Step S808 is performed for each page of the data file. Specifically, the second page and the (n−1)th page of the “***.doc” are specified as the pages, so that immediately after the conversion of the second page into an image, the (n−1)th page is converted into an image.

Thereafter, the image-information obtaining unit 220 converts the page that is specified as the attribute image and is stored in the storing unit 210 corresponding to the extension of the data file received at Step S803 into an image and stores it in the RAM 260 (Step S809).

Then, the symbol creating unit 230 creates the mapping data indicating positions of character strings included in the images created in Steps S805 to S808 (Step S810). Then, the symbol creating unit 230 combines the images of respective pages created in Steps S805 to S808, the attribute image created in Step S809, and the mapping data created in Step S810, reduces the combined image to an image for icon, and stores it in the RAM 260 (Step S811).

When the image in the icon format is stored in the RAM 260, the data communication unit 240 transmits the image to the client terminal 100 via the network 500 (Step S812).

The data communication unit 150 receives image in the icon format transmitted from the server 200 and temporarily stores it in the RAM 170 (Step S813), and then stores it in the storing unit 120 (Step S814) thereby finishing all the processes. When the receiving unit 110 receives an operation from a user such as clicking of the attribute image of the icon or the image of each page, the display control unit 140 sequentially displays the pages of the icon stored in the storing unit 120. In this manner, the user can turn over a page of the icon, enlarge the image of each page, and search for a keyword included in each page.

In the first embodiment, when a user instructs via the client terminal 100 to create an icon, the image-information obtaining unit 220 and the symbol creating unit 230 of the server 200 creates the icon in accordance with the instruction specified by the user. However, for example, when the user wants to sell books on an online bookstore, it is sometimes convenient for the user to create icons of the books by the user (on the client side) and upload them to the server side. Moreover, when the user wants to sell goods on the Internet auction site or the like, the user can specifically explain features of the goods more directly by creating icons describing the goods by the user himself/herself and uploading them to the server side. Therefore, for such cases, in a second embodiment, the attribute image, an image of each page, and the mapping data for a data file are created on the client side, and an image in the icon format in which the attribute image, the image of respective pages, and the mapping data are combined is uploaded to the server side.

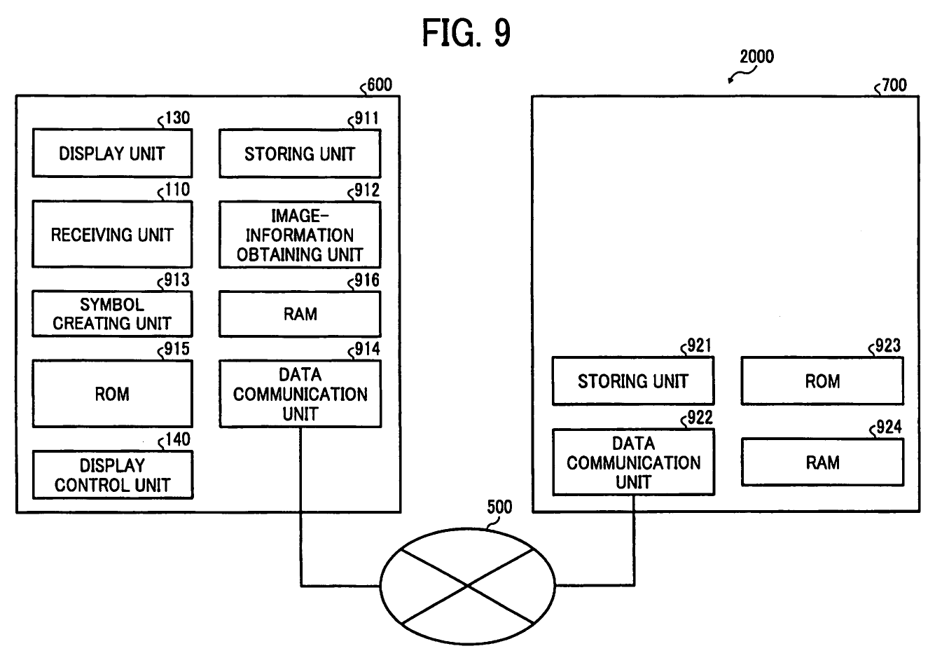

FIG. 9 is a block diagram of an information processing system 2000 according to the second embodiment of the present invention. Components that are the same as those in the first embodiment are given the same reference numerals and explanation thereof is omitted. The information processing system 2000 includes a client terminal 600, a server 700, and the network 500.

The client terminal 600 includes the receiving unit 110, the display unit 130, the display control unit 140, a storing unit 911, an image-information obtaining unit 912, a symbol creating unit 913, a data communication unit 914, a ROM 915, and a RAM 916. The server 700 includes a storing unit 921, a data communication unit 922, a ROM 923, and a RAM 924.

The storing unit 911 stores therein data files as targets for creating icons as shown in FIG. 3 such as a document file and an image, icons of the data files created by the symbol creating unit 913, applications (e.g., Microsoft Word (trademark)) by which the data files are created, and the like. Specific function of the storing unit 911 is the same as the storing unit 120 in the first embodiment, and therefore is not described below.

When the receiving unit 110 receives an input of information such as a page number specifying a portion for creating an icon, the image-information obtaining unit 912 performs processes such as opening a data file stored in the storing unit 911, reading a page as the attribute image target stored, and converting the page into an image. Specific processes performed by the image-information obtaining unit 912 are the same as those by the image-information obtaining unit 220 in the first embodiment, and therefore are not described below.

When the image-information obtaining unit 912 confirms that the attribute image obtained from the data file is created in the RAM 916, the symbol creating unit 913 creates the mapping data indicating positions of character strings included in images. Furthermore, the symbol creating unit 913 combines the created attribute image, the images, and the mapping data, and reduces the combined image to an image for icon. Specific processes performed by the symbol-creating unit 913 are the same as those by the symbol creating unit 230 in the first embodiment, and therefore are not described below.

The data communication unit 914 is a data communication interface between the client terminal 600 and the server 700, and transmits an image in the icon format created by the image-information obtaining unit 912 and the symbol creating unit 913 to the server 700 via the network 500.

The ROM 915 is a storage memory for storing therein computer programs for controlling each unit such as the receiving unit 110, the display control unit 140, the image-information obtaining unit 912, and the symbol creating unit 913.

The RAM 916 is a loading memory for temporarily storing therein an image in the icon format received by the data communication unit 922.

The storing unit 921 is, for example, an HDD or a memory, and stores therein an image in the icon format transmitted from the client terminal 600.

The data communication unit 922 is a data communication interface between the server 700 and the client terminal 600, and receives an image in the icon format transmitted from the client terminal 600.

The ROM 923 is a storage memory for storing therein computer programs for controlling each unit such as the data communication unit 922.

The RAM 924 is a loading memory for temporarily storing therein an image in the icon format received by the data communication unit 922.

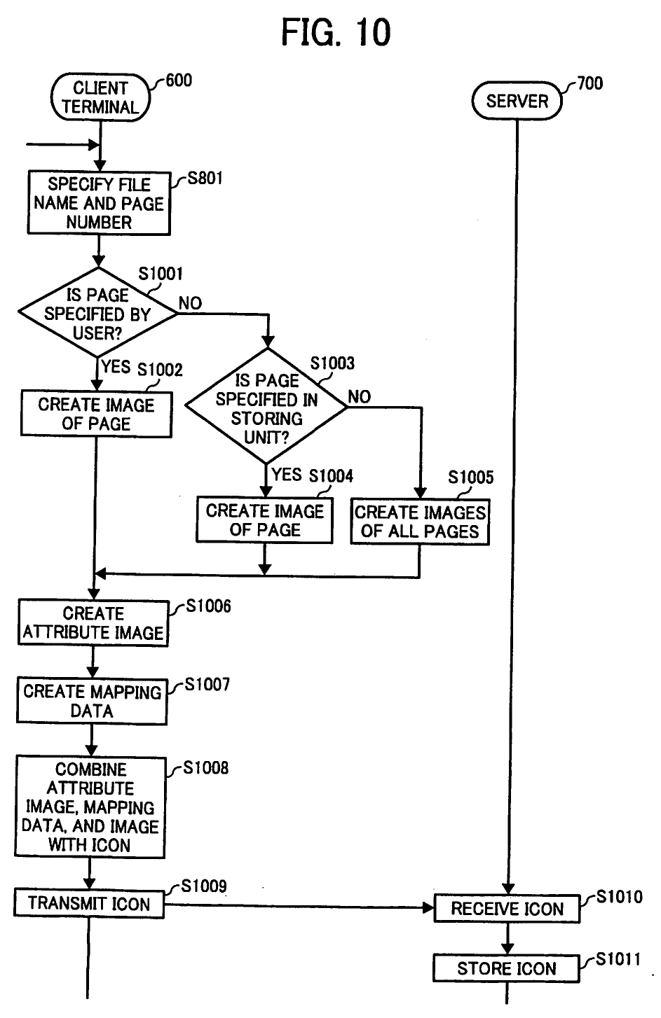

Processes performed by the information processing system 2000 are explained with reference to FIG. 10, which is different from those in the first embodiment in that the image-information obtaining unit 912 and the symbol creating unit 913 perform each process by using data files stored in the storing unit 911 of the client terminal 600 and the server 700 stores an image of the icon format created in the client terminal 600. In the following explanation, only the processes different from those in the first embodiment are described.

After the receiving unit 110 receives an input of a file name and a page number as the icon creation target at Step S801, the image-information obtaining unit 912 confirms whether pages as the icon creation target are specified together with the data file stored in the storing unit 911 (Step S1001). If the image-information obtaining unit 912 confirms that the pages as the icon creation target are specified (YES at Step S1001), the image-information obtaining unit 912 converts the pages into images and stores the images in the RAM 916 (Step S1002).

If the image-information obtaining unit 912 confirms that the pages as the icon creation target are not specified (NO at Step S1001), the image-information obtaining unit 912 specifies an extension same as that of the data file and confirms whether pages as the icon creation target stored corresponding to the extension are stored in the storing unit 911 for the data file (Step S1003). Processes in Steps S1004 to S1009 are the same as those in Steps S807 to S812 in the first embodiment, and therefore the description thereof is omitted.

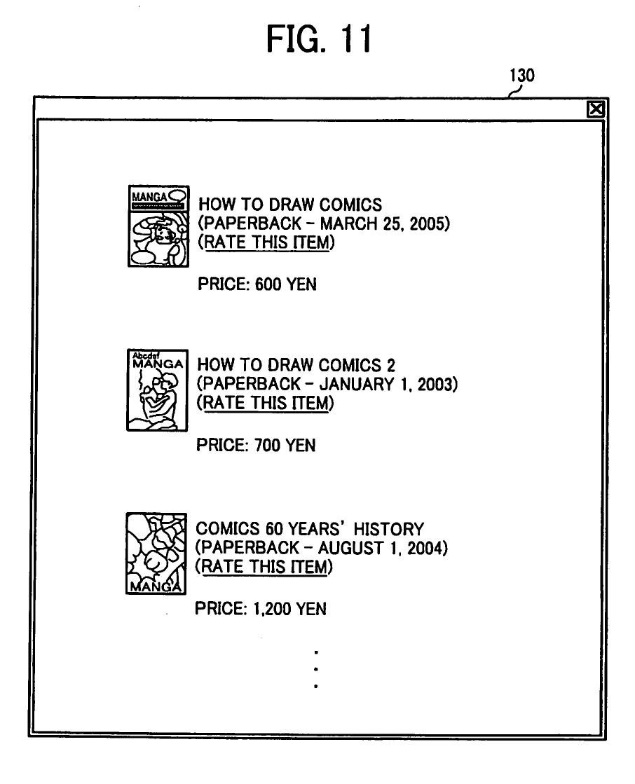

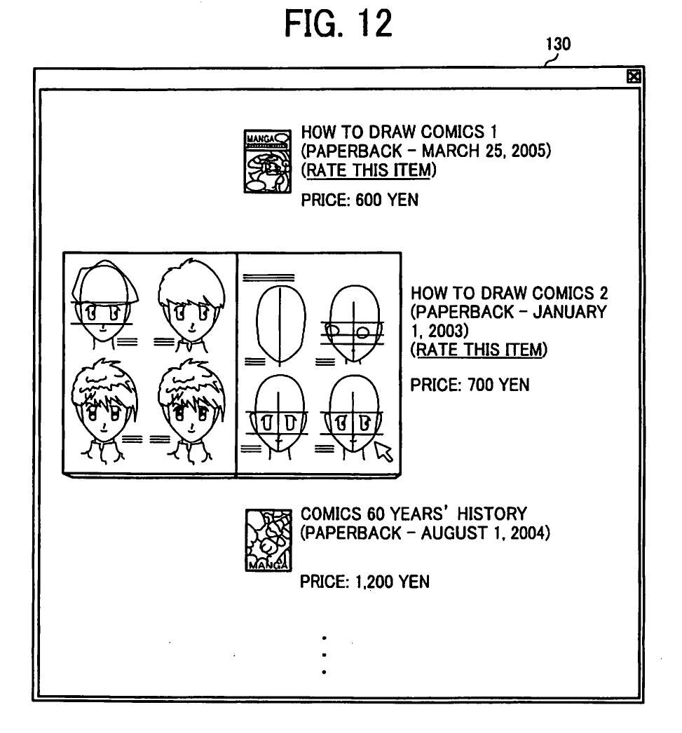

Then, upon receiving the image for icon from the client terminal 600, the data communication unit 922 temporarily stores it in the RAM 924 (Step S1010), and then stores it in the storing unit 921 (Step S1011). Thereafter, the image for icon is registered to the server 700. FIG. 11 is a schematic diagram of an example of a screen of the display unit in a case where books are listed on the Internet auction site by a user. As shown in FIG. 11, the user uploads an image for icon of a book with a title of “How to Draw Comics 2”. Then, the user or others accesses the server 700 from the client terminal or the like, and enlarges the icon or further turn over the page to confirm the content of the book as shown in FIG. 12.

According to the above embodiments, the storing unit 120 or 911 stores therein a symbol of a data file that includes a plurality of pieces of image information of the data file and attribute information indicating the attribute of the data file, the display unit 130 displays the stored symbol, the receiving unit 110 receives an instruction of selecting the symbol, and the display control unit 140, upon receiving the instruction by the receiving unit 110, causes the display unit 130 to sequentially display the plurality of pieces of image information included in the symbol. Therefore, a user can confirm the content of a desired data file easily and quickly without accessing the data file.

Moreover, the display control unit 140, upon receiving an instruction of selecting a symbol by the receiving unit 110, causes the display unit 130 to sequentially display a plurality of pieces of image information included in the symbol to be turned over, so that a user can confirm the content of a desired data file more easily and quickly without accessing the data file.

Furthermore, the storing unit 120 or 911 further stores therein a data file, the image-information obtaining unit 220 or 912 obtains a plurality of pieces of image information from the data file, and the symbol creating unit 230 or 913 changes the size of the image information to a predetermined size and creates a symbol based on the image information of the predetermined size. Therefore, a user can confirm the content of a data file created by himself/herself easily and quickly without accessing the data file.

Moreover, the receiving unit 110 includes a keyboard and a mouse, and the display control unit 140, upon receiving the instruction of selecting a symbol by the keyboard or the mouse, causes the display unit 130 to sequentially display a plurality of pieces of image information included in the symbol. Therefore, a user can confirm the content of a desired data file quickly by a simple operation without accessing the data file.

Furthermore, the display control unit 140, upon receiving an instruction of selecting a symbol by the receiving unit 110, enlarges or reduces the size of a plurality of pieces of image information included in the symbol, so that a user can confirm the content of a desired data file quickly by a simple operation without accessing the data file.

Moreover, the display control unit 140, after attribute information that indicates an attribute of a data file and is included in a symbol is displayed on the display unit 130, causes the display unit 130 to sequentially display a plurality of pieces of image information of the data file. Therefore, a user can confirm the symbol of the data file even if all the image information of the data file has not been created.

Furthermore, the symbol creating unit 230 or 913 sequentially changes the size of a plurality of pieces of image information to a predetermined size and renews a created symbol every time the size of a piece of the image information is changed. Therefore, a user can confirm the content of a data file quickly for the created image information even if all the image information of the data file has not been created.

Moreover, the receiving unit 110 further receives an instruction of specifying image information of a data file, and the image-information obtaining unit 220 or 912 obtains only the specified image information among a plurality of pieces of image information of the data file, so that even when the capacity of the data file is large, a user can confirm the content of the data file easily and quickly.

Furthermore, attribute information indicating an attribute of a data file includes file-type identification information indicating a type of the data file, the storing unit 120 or 911 stores the file-type identification information and specification information indicating image information as a target to be obtained from the data file while associating them with each other, and the image-information obtaining unit 220 or 912 obtains only the image information specified by the specification information corresponding to the file-type identification information from the data file based on the file-type identification information and the specification information. Therefore, even when a user does not specify image information of the data file as a target to be obtained, the user can confirm the content of the data file easily and quickly.

Moreover, the image-information obtaining unit 220 or 912 further includes a position-information obtaining unit that obtains position information of character strings included in image information of a data file or attribute information indicating an attribute of the data file, and the display control unit 140 causes the display unit 130 to highlight and sequentially display the character strings included in the image information based on the character strings included in the image information specified through the receiving unit 110 or the image information specified by the specification information and the position information of the character strings. Therefore, a user can find a portion that the user wants to confirm in the content of the data file easily and quickly.

Furthermore, the receiving unit 110 receives an instruction to open a data file, the storing unit 120 or 911 stores pages constituting the data file and image information constituting a symbol while associating them with each other, and the display control unit 140 causes the display unit 130 to display pages constituting the data file corresponding to the image information included in the symbol that corresponds to the instruction to open the data file. Therefore, a user can quickly access to a desired portion in a data file after confirming the content of the data file by a symbol.

Moreover, the data communication unit 240 receives a data file as a request for creating a symbol from the client terminal 100 connected to the network 500, the data communication unit 240 transmits a symbol that the symbol creating unit 230 has created to the client terminal 100, and the image-information obtaining unit 220 obtains a plurality of pieces of image information from the data file that the data communication unit 240 has received. Therefore, even when there is a request for creating a symbol from a client terminal connected to a network, it is possible to provide a symbol capable of confirming the content of a data file thereof more easily and quickly without accessing the data file.

In the above embodiments, the client terminal 600 or the server 200 creates an image in the icon format, and display the image on the client terminal 600 or the like. However, some users want to store computer programs for creating an icon in a server, and cause a plurality of client terminals to create images in the icon format by downloading the computer programs to the client terminals. In a third embodiment, client terminals download computer programs for creating an image in the icon format stored in a server, and install the programs thereby creating an image for icon.

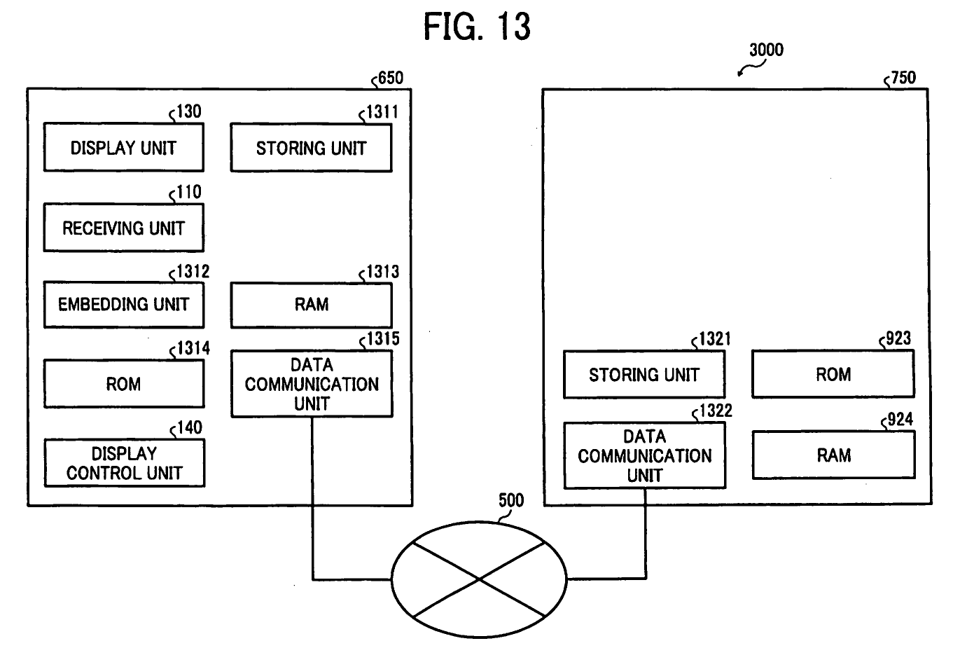

FIG. 13 is a block diagram of an information processing system 3000 according to a third embodiment of the present invention. Components that are the same as those in the first and second embodiments are given the same reference numerals and explanation thereof is omitted. The information processing system 3000 includes a client terminal 650, a server 750, and the network 500.

The client terminal 650 includes the receiving unit 110, the display unit 130, the display control unit 140, a storing unit 1311, an embedding unit 1312, a RAM 1313, a ROM 1314, and a data communication unit 1315. The server 750 includes the ROM 923, the RAM 924, a storing unit 1321, and a data communication unit 1322.

The storing unit 1311 stores therein various data such as the data file described in the second embodiment and computer programs for obtaining images or creating icons that are installed by the embedding unit 1312.

When the receiving unit 110 receives an input of an instruction to install the computer programs for obtaining images or creating icons, the embedding unit 1312 downloads the computer programs stored in the storing unit 1321 and stores them in the storing unit 1311.

The RAM 1313 is a loading memory for loading computer programs or data such as an HDD or a memory and temporarily stores therein computer programs that the data communication unit 1315 receives.

The ROM 1314 is a storage memory for storing therein computer programs for controlling each unit such as the embedding unit 1312 and the data communication unit 1315.

The data communication unit 1315 is a data communication interface between the client terminal 650 and the server 750, and transmits a request for downloading computer programs from the embedding unit 1312 to the server 750. Moreover, the data communication unit 1315 receives the computer programs for obtaining images or creating icons from the server 750.

The storing unit 1321 is, for example, an HDD or a memory, and stores therein the computer programs for obtaining images or creating icons.

Processes performed by the information processing system 3000 are briefly explained. When the receiving unit 110 receives a request for downloading computer programs from a user, the embedding unit 1312 downloads the computer programs via the data communication unit 1315 and stores them in the storing unit 1311. Then, the processes same as those in Steps S801 to S1001 in the second embodiment are performed by using the computer programs (e.g., the display control unit 140), thereby finishing all the processes.

According to the present embodiment, in the client terminal 650, the receiving unit 110 receives an instruction of a request for providing computer programs that include the display control unit 140, the image-information obtaining unit 912, and the symbol creating unit 913, the data communication unit 1315 transmits the request received by the receiving unit 110 to the server 750 and receives the requested computer programs, and the embedding unit 1312 embeds the computer programs in the storing unit 1311. In the server 750, the data communication unit 1322 receives the request for providing the computer programs and transmits the computer programs stored in the storing unit 1321 to the client terminal 650 in accordance with the request, and the storing unit 1321 stores the computer programs. Therefore, even when there is a request for providing computer programs for creating a symbol from other information processing apparatus, it is possible to provide the computer programs for creating a symbol capable of confirming the content of a data file thereof more easily and quickly without users accessing the data file.

In the present embodiment, the computer programs executed in the client terminal 650 are downloaded over the network; however, can be provided in such a way that the computer programs are recorded as an installable format file or executable format file in a computer-readable recording medium such as a compact disk read only memory (CD-ROM), a flexible disk (FD), a compact disk recordable (CD-R), and a digital versatile disk (DVD).

In the present embodiment, the computer programs to be executed on the client terminal 650 have a module configuration including each unit explained above such as the image-information obtaining unit and the symbol creating unit. As actual hardware, a central processing unit (CPU) (processor) reads the computer programs from the ROM for execution, thereby loading each unit onto a main storage device and generating the image-information obtaining unit, the symbol creating unit, and the like.

In the above embodiments, the information processing apparatus is employed as an example; however, it is not limited thereto. Various other apparatuses including an image forming apparatus can be also employed such as a copier, a facsimile, a printer, and a multi function peripheral (MFP) that includes a copier function, a facsimile function, a printer function, a scanner function, and the like

According to one aspect of the present invention, a user can confirm the content of a desired data file easily and quickly without accessing the data file.

Furthermore, according to another aspect of the present invention, a user can confirm the content of a data file created by the user easily and quickly without accessing the data file.

Moreover, according to still another aspect of the present invention, a user can confirm the content of a desired data file quickly by a simple operation without accessing the data file.

Furthermore, according to still another aspect of the present invention, a user can confirm a symbol of a data file even if all image information of the data file has not been created.

Moreover, according to still another aspect of the present invention, a user can confirm the content of a data file quickly for created image information even if all image information of the data file has not been created.

Furthermore, according to still another aspect of the present invention, even when the capacity of a data file is large, a user can confirm the content of the data file easily and quickly.

Moreover, according to still another aspect of the present invention, even when a user does not specify image information of a data file as a target to be obtained, the user can confirm the content of the data file easily and quickly.

Furthermore, according to still another aspect of the present invention, a user can find a portion that the user wants to confirm in the content of a data file easily and quickly.

Moreover, according to still another aspect of the present invention, a user can quickly access to a desired portion in a data file after confirming the content of the data file by a symbol.

Furthermore, according to still another aspect of the present invention, even when there is a request for creating a symbol from other information processing apparatus connected to a network, it is possible to provide the symbol capable of confirming the content of a data file thereof more easily and quickly without users accessing the data file.

Moreover, according to still another aspect of the present invention, even when there is a request for providing a computer program for creating a symbol from other information processing apparatus connected to a network, it is possible to provide the computer programs for creating the symbol capable of confirming the content of a data file thereof more easily and quickly without users accessing a data file of the symbol.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that displays an attribute of a data file, the information processing apparatus comprising:
a storing unit that stores therein a symbol of the data file, the symbol including image information of the data file and attribute information of the data file indicating the attribute of the data file;
a display unit that displays thereon the symbol;
a receiving unit that receives a selection instruction of selecting the symbol displayed on the display unit; and
a display control unit that, upon the receiving unit receiving the selection instruction, sequentially displays a plurality of pieces of image information included in the symbol on the display unit.

2. The information processing apparatus according to claim 1, wherein upon the receiving unit receiving the selection instruction, the display control unit sequentially displays the pieces of image information in such a manner that the pieces of image information are sequentially turned over.

3. The information processing apparatus according to claim 1, wherein
the storing unit further stores therein the data file, and
the information processing apparatus further comprises:
an image-information obtaining unit that obtains the image information from the data file; and
a symbol creating unit that changes sizes of the pieces of image information to predetermined sizes, and creates the symbol based on size-changed pieces of image information.

4. The information processing apparatus according to claim 1, wherein
the receiving unit includes at least one of a key-operation input unit and a pointer-operation input unit, and
upon either one of the key-operation input unit and the pointer-operation input unit receiving the selection instruction, the display control unit sequentially displays the pieces of image information included in the symbol on the display unit.

5. The information processing apparatus according to claim 1, wherein upon the receiving unit receiving the selection instruction, the display control unit scales a display of the image information.

6. The information processing apparatus according to claim 3, wherein the display control unit sequentially displays the pieces of image information on the display unit after displaying the attribute image.

7. The information processing apparatus according to claim 6, wherein the symbol creating unit creates the symbol for every size-changed pieces of image information.

8. The information processing apparatus according to claim 3, wherein
the receiving unit further receives an instruction of specifying the image information of the data file, and
the image-information obtaining unit obtains the image information specified from among the pieces of image information of the data file.

9. The information processing apparatus according to claim 3, wherein
the attribute information includes file-type identification information indicating a type of the data file,
the storing unit further stores therein the file-type identification information and specification information indicating image information to be obtained from the data file in association with each other, and
the image-information obtaining unit obtains the image information specified by the specification information corresponding to the file-type identification information from the data file.

10. The information processing apparatus according to claim 8, wherein
the image-information obtaining unit further includes a position-information obtaining unit that obtains position information of character strings included in either one of the image information and the attribute information, and
the display control unit highlights and sequentially displays the character strings based on the position information and character strings included in the image information specified through the receiving unit or the image information specified by the specification information and the position information on the display unit.

11. The information processing apparatus according to claim 9, wherein
the image-information obtaining unit further includes a position-information obtaining unit that obtains position information of character strings included in either one of the image information and the attribute information, and
the display control unit highlights and sequentially displays the character strings based on the position information and character strings included in the image information specified through the receiving unit or the image information specified by the specification information and the position information on the display unit.

12. The information processing apparatus according to claim 1, wherein
the receiving unit receives an instruction to open the data file,
the storing unit further stores therein a page constituting the data file and the image information included in the symbol in association with each other, and
the display control unit displays a page corresponding to the image information included in the symbol corresponding to the instruction on the display unit.

13. The information processing apparatus according to claim 3, further comprising:
a first receiving unit that is connected to a first information processing apparatus via a network and receives a data file for which a creation of the symbol is requested from the first image processing apparatus; and
a first transmitting unit that transmits the symbol created by the symbol creating unit to the first information processing apparatus, wherein
the image-information obtaining unit obtains the image information from the data file received by the first receiving unit.

14. The information processing apparatus according to claim 13, wherein
the first image processing apparatus includes
a second transmitting unit that transmits a request for providing a program that includes the display control unit, the image-information obtaining unit, and the symbol creating unit,
a second receiving unit that receives the program provided in response to the request, and
an embedding unit that embeds the program received by the second receiving unit in the storing unit,
the receiving unit receives an instruction of the request for providing the program,
the second transmitting unit transmits the instruction received by the receiving unit to the information processing apparatus,
the information processing apparatus further includes
a third receiving unit that receives the instruction transmitted from the second transmitting unit;
a program storing unit that stores therein the program; and
a third transmitting unit that transmits the program stored in the program storing unit to the first information processing apparatus according to the instruction received by the third receiving unit.

15. An information processing apparatus that displays an attribute of a data file, the information processing apparatus comprising:
a storing means for storing a symbol of the data file, the symbol including image information of the data file and attribute information of the data file indicating the attribute of the data file;
a displaying means for displaying the symbol;
a receiving means for receiving a selection instruction of selecting the symbol displayed on the display means; and
a display control means for, upon the receiving means receiving the selection instruction, sequentially displaying a plurality of pieces of image information included in the symbol on the display means.

16. A computer program product comprising a computer-usable medium having computer-readable program codes embodied in the medium for an information processing apparatus that displays an attribute of a data file, the program codes when executed causing a computer to execute:
storing a symbol of the data file, the symbol including image information of the data file and attribute information of the data file indicating the attribute of the data file;
displaying the symbol on a display unit;
receiving a selection instruction of selecting the symbol displayed at the displaying; and
controlling including, when the selection instruction is received at the receiving, sequentially displaying a plurality of pieces of image information included in the symbol on the display unit.
